(19) United States
(12) Patent Application Publication
(10) Pub. No.: US 2014/0201458 A1
(43) Pub. Date: Jul. 17, 2014

(54) REDUCING CACHE MEMORY REQUIREMENTS FOR RECORDING STATISTICS FROM TESTING WITH A MULTIPLICITY OF FLOWS

(71) Applicants: Craig Fujikami, Honolulu, HI (US); Jocelyn Kunimitsu, Honolulu, HI (US)

(72) Inventors: Craig Fujikami, Honolulu, HI (US); Jocelyn Kunimitsu, Honolulu, HI (US)

(73) Assignee: Spirent Communications, Inc., Sunnyvale, CA (US)

(21) Appl. No.: 13/743,999

(22) Filed: Jan. 17, 2013

(51) Int. Cl. G06F 12/12

(52) U.S. Cl. CPC G06F 12/122
USPC 711/136

(57) ABSTRACT

A method reduces cache memory requirements for testing a multiplicity of flows. The method includes receiving data corresponding to a frame in a particular flow among the multiplicity of flows. In response to the frame received, the method updates a set of cached flow counters in cache memory for the particular flow. The method updates one or more regular operation counters and one or more conditional counters among the set of cached flow counters, including a last serviced counter. The method updates, responsive to any error conditions, one or more error condition counters among the set of cached flow counters. The method evaluates whether to transfer values from the cached flow counters to system accumulators in system memory using at least a value in the last serviced counter for the particular flow. Responsive to the evaluating, the method transfers the values from the cached flow counters to the system accumulators.

### BACKGROUND

The technology disclosed relates to testing internet traffic flows. In particular, it relates to reducing cache memory requirements for recording statistics from testing with a multiplicity of flows.

When testing the internet traffic, thousands or millions of flows may be tracked and analyzed. Statistics about each of the flows, such as frame and byte counts, are counted and stored in memory. As such, smaller and faster cache memory may be suitable to keep track of the counters at high bandwidth rates, while high density system memory such as DRAMs (dynamic random access memory) may be suitable to store the statistics for the multiplicity of flows accumulated by counters. The size of the counters in the cache memory depends on how quickly the statistics generated by the counters in the cache memory can be transferred into and accumulated by larger but slower system memory. The size of the cache memory limits both the number of statistics counters available per flow and the number of total flows that can be tracked and analyzed simultaneously.

An opportunity arises to provide a method and apparatus to reduce the size of the counters in the cache memory such that the number of flows and/or the number of statistics tracked per flow can be increased without increasing the size of the cache memory.

### SUMMARY

One implementation of the technology disclosed describes a method that reduces cache memory requirements for testing a multiplicity of flows. The method includes receiving data corresponding to a frame in a particular flow among the multiplicity of flows. In response to the frame received, the method updates a set of cached flow counters in cache memory for the particular flow. The method updates one or more regular operation counters and one or more conditional counters among the set of cached flow counters, including a last serviced counter. The method updates, responsive to any error conditions detected, one or more error condition counters among the set of cached flow counters. The method evaluates whether to transfer values from the cached flow counters to system memory using at least a value in the last serviced counter for the particular flow. Responsive to the evaluating, the method transfers the values from the cached flow counters to the system accumulators.

Particular aspects of the technology disclosed are described in the claims, specification and drawings.

### BRIEF DESCRIPTION OF THE DRAWINGS

FIG. 1 illustrates a block diagram of an example computing system in which cache memory requirements for recording statistics from testing with a multiplicity of flows can be reduced.

FIG. 2 illustrates a block diagram of example modules within a processor in the example computing system.

FIG. 3 illustrates a cache memory storing statistics for the multiplicity of flows.

FIG. 4 illustrates statistics tracked for each flow among the multiplicity of flows.

FIG. 5 is a flow chart for round-robin maintenance transfers.

FIG. 6 is a flow chart for evaluation-based maintenance transfers.

FIG. 7 is a flow chart for updating system accumulators in system memory.

### DETAILED DESCRIPTION

The following detailed description is made with reference to the figures. Examples are described to illustrate the technology disclosed, not to limit its scope, which is defined by the claims. Those of ordinary skill in the art will recognize a variety of equivalent variations on the description that follows.

In a test system that generates a multiplicity of network traffic flows, on the order of thousands or millions of simultaneous flows, fast cache memory is used to count statistics for each flow at high rates compatible with the flows. The system needs to track and analyze thousands of flows simultaneously and accurately. It uses high density system memory to accumulate statistics from counters for the thousands of flows. The system transfers statistic counts from the cache memory to the system memory. The transfers may be scheduled by a conventional round-robin maintenance transfer schedule. The fast cache memory is more expensive than the system memory. It can be economically prohibitive to build a system that includes as much cache memory as required by a round-robin maintenance transfer schedule. Applicants have discovered that the source of requirements for a large cache memory is the large size of individual cached flow counters (number of bits each), dictated by the round-robin maintenance schedule. By using a more efficient maintenance transfer approach disclosed in this application, the system can reduce the size for cached flow counters for each of the thousands of flows tracked by the system, and accordingly reduce the cache memory requirements.

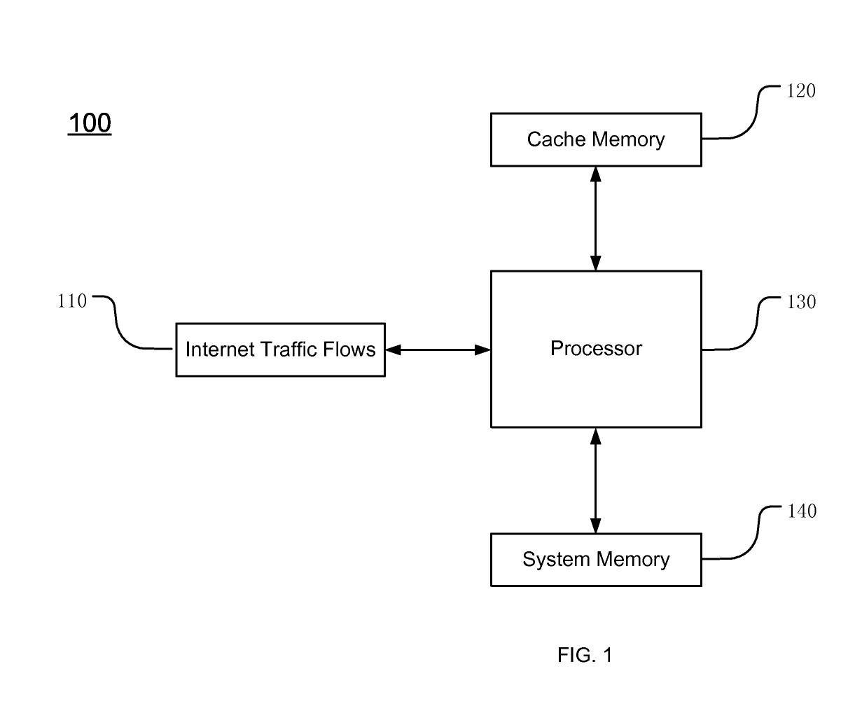

FIG. 1 illustrates a block diagram of an example computing system 100 in which cache memory requirements for recording statistics from testing with a multiplicity of flows can be reduced in accordance with the technology disclosed. The computing system 100 can include one or more processor. For example, a processor 130 communicates with a multiplicity of internet traffic flows 110 at a communication line rate such as 1 GbE (Gigabit Ethernet). The cache memory 120 stores statistics about the flows using the cached flow counters. The processor 130 transfers the values from the cached flow counters to corresponding system accumulators in the system memory 140. The values from the cached flow counters must be transferred to the system memory 140 in a timely manner such that no information is lost. Typically, the cache memory 120 has a faster speed than the system memory 140, while the system memory 140 has a higher density than the cache memory 120.

Requirements for per stream/flow statistics are described below. A worst case size for the cached flow counters is derived using a 1 GbE (Gigabit Ethernet) system as an example. The technology disclosed reduces the worst case cache counter size.

The worst case size for the cached flow counters is determined by a few factors. In the example, the computing system 100 tracks 2¹⁴ or 16,384 independent flows, and it takes 10 μs (micro second) to transfer values from cached flow counters for one flow to the system memory 140. The communication line rate for the multiplicity of flows is 1 GbE (Gigabit Ethernet at 1×10⁹ bits per second). A minimum frame size in an internet traffic stream/flow is 64 bytes, plus an 8 byte preamble, and plus a 12 byte gap, for a total of 84 bytes per frame.

Accordingly, at 1 GbE line rate, the minimum frame spacing is 672 ns (=84 bytes times 8 bits per byte divided by 1×10⁹ bits per second), or 1.488 million frames per second, where a frame spacing is the time to transmit a frame. The time required to sequentially transfer values from cached flow counters for 16,384 flows is 163,840 μs (=2¹⁴ times 10 μs per flow). Thus if a round robin maintenance transfer schedule is used, the period of the round robin maintenance transfers is 163,840 μs. Since the system must be designed such that it doesn't lose any information under all circumstances, e.g., when only 1 flow is active and when all 16K flows are active, the counter sizes must be sized for the worst case.

The worst case is when one flow is running at 1.488 million frames per second using the round-robin maintenance transfer schedule. In this case, the one active flow is transferred once per round robin period, or once every 163,840 μs. Up to 0.244 million frames (=163,840 μs times 1.488 million frames per second may occur during the period. To guarantee no loss of information, the size of the cached flow counters must be able to hold at least twice 2¹⁸, so an upper limit (Lᵤₚₚₑᵣ) for the size of cached flow counters of 19 bits (=18+1) is required per frame counter.

In general, given:
N_{flow}=number of flows in the multiplicity of flows
T_{xfer}=time to transfer values in cached flow counters for one flow to system memory
Rₗᵢₙₑ=a communication line rate for the multiplicity of flows
S_{frame}=minimum frame size including a preamble and a gap, the upper limit (Lᵤₚₚₑᵣ) for the size of the cached flow counters may be derived as follows:
T_{frame}=minimum frame spacing=S_{frame}/Rₗᵢₙₑ
P_{RR}=round robin period=N_{flow}×T_{xfer}
N_{RR}=number of frames received in P_{RR}=P_{RR}/T_{frame}
Lᵤₚₚₑᵣ=1+log₂ (N_{RR})
Lᵤₚₚₑᵣ=1+log₂ (N_{flow}×T_{xfer}×Rₗᵢₙₑ/S_{frame})

Thus, the upper limit (Lᵤₚₚₑᵣ) for the size of the cached flow counters may be derived from one plus the logarithm base 2 of: the number of flows in the multiplicity of flows, times the time to transfer values in cached flow counters for one flow to the system memory, times a communication line rate for the multiplicity of flows, and divided by a minimum frame size for the multiplicity of flows. Further, a ceiling function may be applied to the result of the logarithm such that any fraction in the result is rounded up to the nearest integer. The addition of one (1) is to guarantee no loss of information when transferring values from the cached flow counters to the system memory. Cached flow counters with size lower than Lᵤₚₚₑᵣ may risk loss of information, when the round-robin maintenance transfer schedule is used. Using the example described, N_{flow}=2¹⁴=16,384, T_{xfer}=10×10⁻⁶ seconds, Rₗᵢₙₑ=1×10⁹ bitsper second, and S_{frame}=84 bytes×8 bits=672 bits. The resulting bits size of a counter is:

Lᵤₚₚₑᵣ=1+ceiling (log₂ (2¹⁴×10×10⁻⁶×1×10⁹/672))=19 (bits)

where a ceiling function is applied to the result of the logarithm. The upper limit (Lᵤₚₚₑᵣ) increases with increasing communication line rates (Rₗᵢₙₑ). For instance, if the communication line rate (Rₗᵢₙₑ) is increased to 100 GbE (100×10⁹ bits per second), the resulting bits size of a counter is:

Lᵤₚₚₑᵣ=1+ceiling (log₂ (2¹⁴×10×10⁻⁶×100×10⁹/672))=26 (bits)

The upper limit (Lᵤₚₚₑᵣ) also increases with increasing number of flows (N_{flow}). For instance, if the number of flows (N_{flow}) is increased to 1,048,576 at Rₗᵢₙₑ=1×10⁹ bits per second and T_{xfer}=10×10⁻⁶ seconds, the resulting bits size of a counter is:

Lᵤₚₚₑᵣ=1+ceiling (log₂ (1,048,576×10×10⁻⁶×10⁹/672))=25 (bits)

The technology disclosed reduces the size of cached flow counters to a lower limit (L_{lower}) as described in a new approach below.

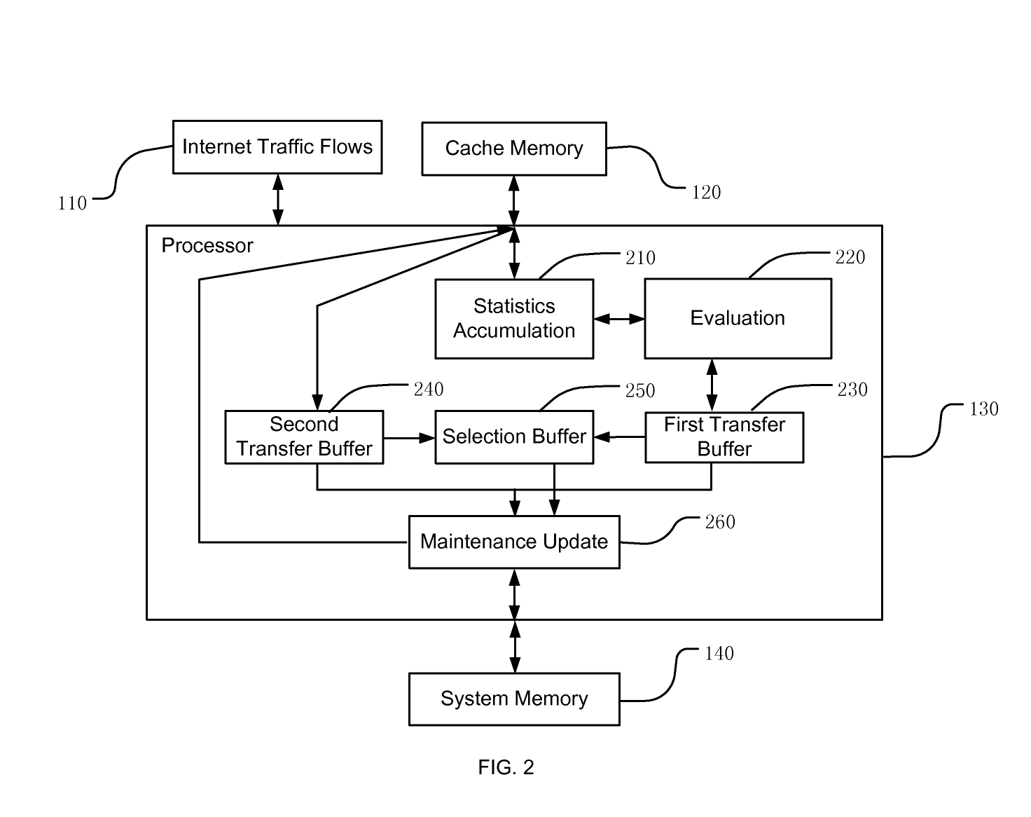

FIG. 2 illustrates a block diagram of example modules within the processor 130 in the example computing system 100. The processor 130 can be implemented in an integrated circuit such as a field programmable gate array (FPGA), a programmable logic device (PLD), an application specific integrated circuit (ASIC), a reduced instruction set computing (RISC) device, an advanced RISC machine (ARM), a digital signal processor (DSP), etc. The processor 130 can include a statistics accumulation module 210, an evaluation module 220, a first transfer buffer 230, a second transfer buffer 240, a selection buffer 250, and a maintenance update module 260.

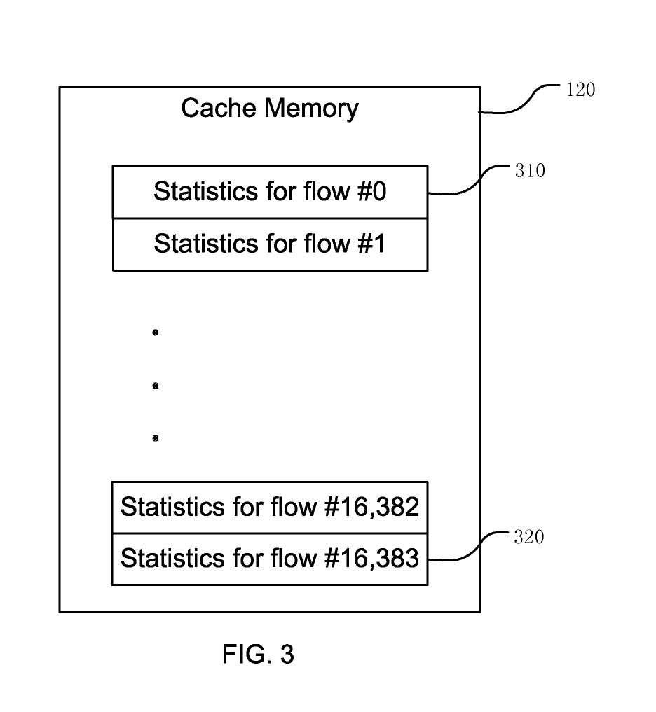

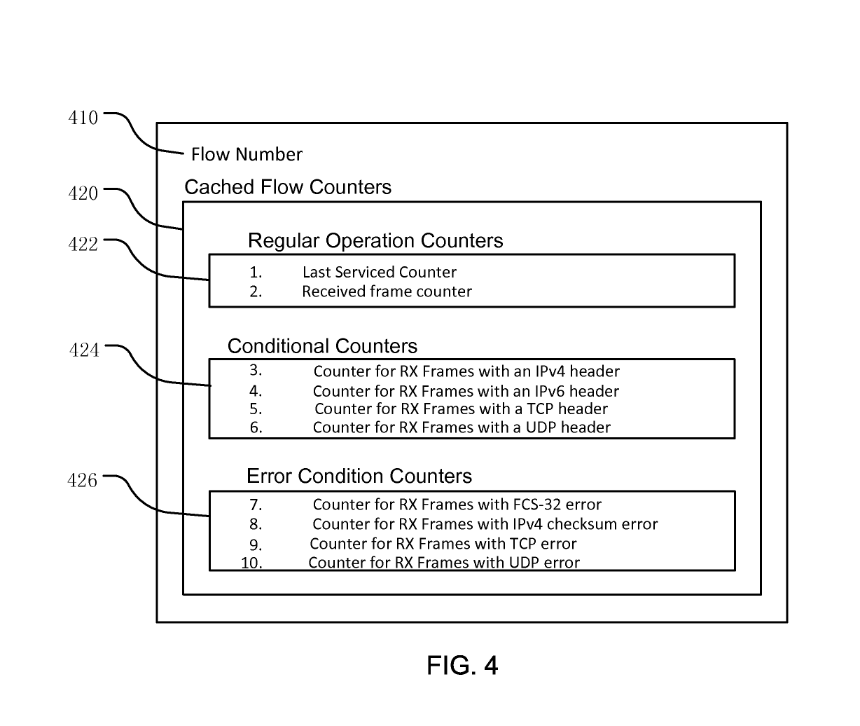

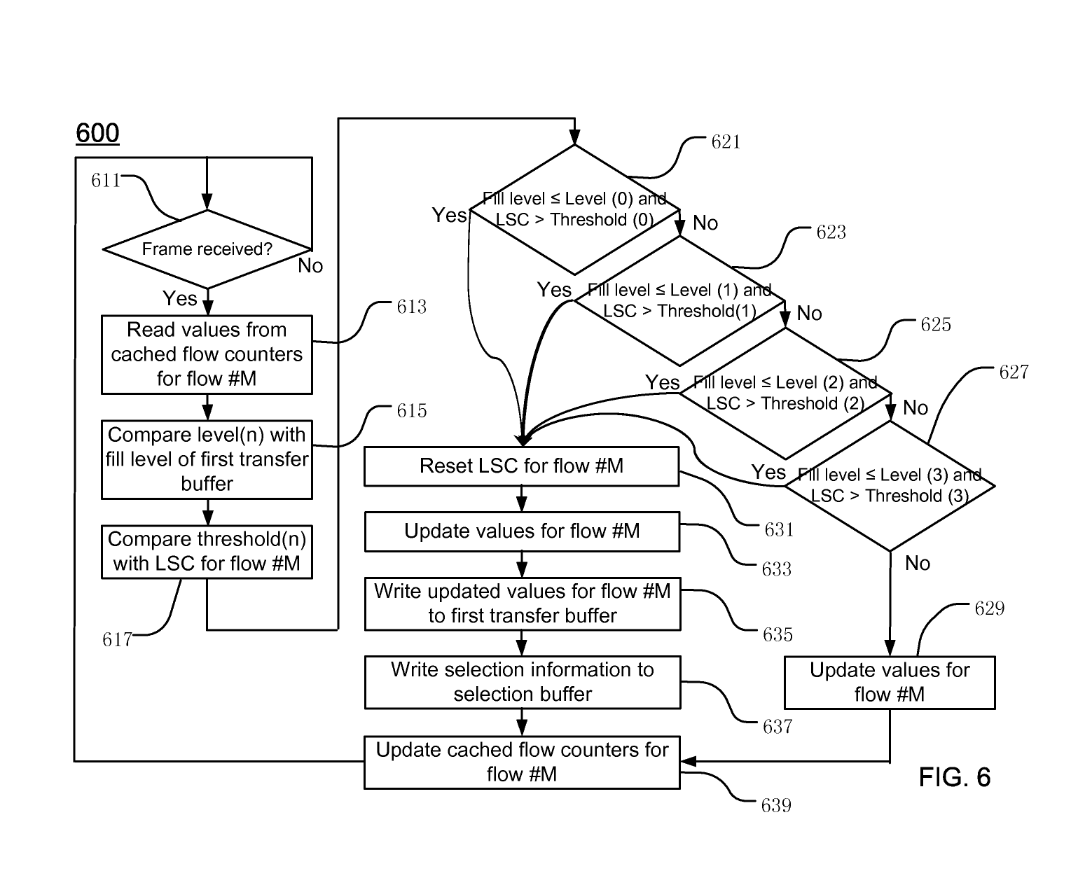

The statistics accumulation module 210 accumulates statistics about frames received in the internet traffic flows 110. Details about the statistics are described in connection with FIG. 3 and FIG. 4. The evaluation module 220 evaluates whether to transfer values from the cached flow counters to system accumulators. Details about the evaluation are described in connection with FIG. 6.

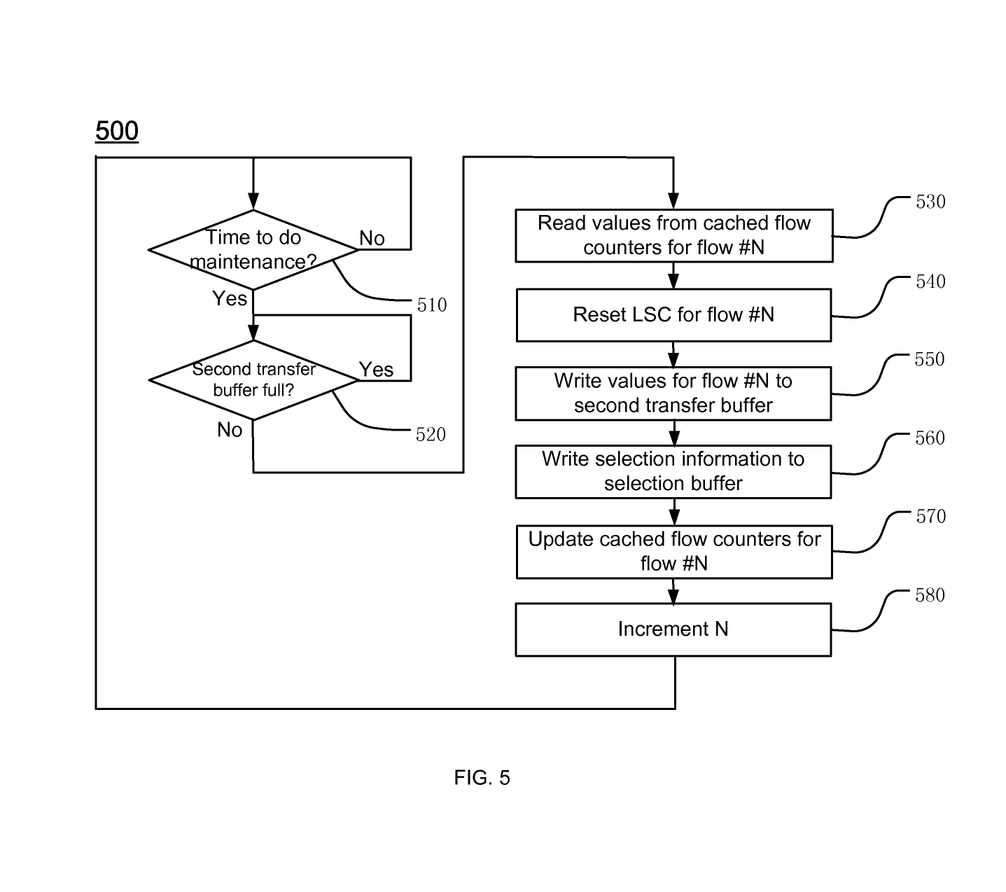

The first transfer buffer 230 queues flows that are ready to have values from their cached flow counters transferred to the system accumulators, as determined by the evaluation module 220. The first transfer buffer 230 maintains a fill level to indicate the fullness of the buffer. The second transfer buffer 240 queues flows based on the round-robin maintenance transfer schedule. The first transfer buffer 230 and the second transfer buffer 240 may have the same or different depths. For one example, both the first transfer buffer 230 and the second transfer buffer 240 may have a depth of 32. For another example, the first transfer buffer 230 may have a depth of 64, while the second transfer buffer 240 may have a depth of 32. Details about the round-robin maintenance transfers are described in connection with FIG. 5. The selection buffer 250 registers whether a flow is queued in the first transfer buffer 230 or the second transfer buffer 240 in the order the flows are queued. Transfers scheduled with evaluation are referred to as prioritized transfers. Transfers scheduled according to round-robin maintenance are referred to as round-robin transfers.

The maintenance update module 260 determines the order in which to transfer values from the first transfer buffer and the second transfer buffer to the system accumulators by using the selection buffer 250. For cached flow counters of size n, where n is the number of bits each cached flow counter has, the cached flow counters roll over after 2ⁿ increments. The system accumulators include lower sub-accumulators and upper sub-accumulators. The lower sub-accumulators have the same lengths as the cached flow counters. The values from the cached flow counters are compared to values stored in the lower sub-accumulators. The upper sub-accumulators are incremented, for example by one, when the values from the cached flow counters are less than values from the corresponding lower sub-accumulators. A lower value in a cached flow counter than in the corresponding lower sub-accumulator indicates that the counter has rolled over since its last transfer to system memory. The values from cached flow counters are stored in the lower sub-accumulators.

The selection buffer 250 records the order in which flows are queued in the first transfer buffer and the second transfer buffer. The maintenance update module 260 reads the values from the first transfer buffer and the second transfer buffer in the same order, to ensure that a rollover can be determined by comparing values from cached flow counters with values from corresponding sub-accumulators. If the order is not maintained, false rollovers may be caused by miss-ordering the data in the first transfer buffer and the second transfer buffer.

In an alternative implementation, a single transfer buffer may replace the first transfer buffer and the second transfer buffer. Both prioritized transfers and round-robin transfers are queued in the single transfer buffer. The order as maintained by the selection buffer is inherent in the single buffer. In this implementation, two virtual fill levels are tracked separately for prioritized transfers and round-robin transfers queued in the same single transfer buffer.

FIG. 3 illustrates the cache memory 120 storing statistics for the multiplicity of flows. The example computing system 100 can keep track of 2¹⁴ or 16,384 independent flows. The cache memory 120 stores statistics for each of the flows, from flow #0 (310) to flow #16,383(320).

FIG. 4 illustrates statistics tracked for each flow among the multiplicity of flows, whether the flow is queued in the first transfer buffer or the second transfer buffer. Each flow has a flow number 410, and statistics stored in a set of cached flow counters 420. Values from the cached flow counters for one flow are entered as one entry in the first transfer buffer or the second transfer buffer when the flow is queued. The set of cached flow counters 420 includes one or more regular operation counters 422, one or more conditional counters 424, and one or more error condition counters 426.

For instance, the regular operation counters 422 include a last serviced counter and a received frame counter. The last serviced counter counts the number of frames for a particular flow since the last time the values from the cached flow counters for the particular flow were transferred to the system memory. The last serviced counter is reset to zero whenever the cached information for that particular flow is transferred, whether from the first transfer buffer or the second transfer buffer. For instance, the conditional counters 424 include a counter for RX frames with an IPv4 header, and a counter for RX frames with a TCP header. For instance, the error condition counter 426 includes a counter for RX frames with FCS-32 error and a counter for RX frames with IPv4 checksum error.

In this example, 10 frame counters are used per flow. If each frame counter has 19 bits as determined for Lᵤₚₚₑᵣ when the round-robin maintenance transfers are used, then 190 bits are required in the cache memory 120 for each flow. Since 16,384 independent flows are tracked, the total requirement for cache ram is 16,384×190 bits=4 Mbits. With the round-robin maintenance transfers, in addition to the cache memory requirement of 4 Mbits, there is also a memory bandwidth requirement to read and write 190 bits for each transfer per flow. If each frame counter has fewer bits, both the cache memory requirement and the memory bandwidth requirement can be reduced.

The technology disclosed provides a method that reduces cache memory requirements for testing a multiplicity of flows. The method includes receiving data corresponding to a frame in a particular flow among the multiplicity of flows (110). In response to the frame received, the method updates a set of cached flow counters (420) in cache memory (120) for the particular flow. The method updates one or more regular operation counters (422) among the set of cached flow counters, including a last serviced counter. The method updates one or more conditional counters (424) among the set of cached flow counters. The method updates, responsive to any error conditions detected, one or more error condition counters (426) among the set of cached flow counters. The method evaluates whether to transfer values from the cached flow counters to system accumulators in system memory (140) using at least a value in the last serviced counter for the particular flow. Responsive to the evaluating, the method transfers the values from the cached flow counters to the system accumulators.

In one implementation, the method interleaves prioritized transfers with round-robin transfers of values from the cached flow counters to the system accumulators. The method includes queueing the prioritized transfers and the round-robin transfers of the values from the cached flow counters, maintaining an order in which the prioritized transfers and the round-robin transfers are queued; and transferring values from the cached flow counters to the system accumulators in the order maintained.

In one implementation, the method may queue the prioritized transfers by using a first transfer buffer, queue the round-robin transfers by using a second transfer buffer, and maintain the order in which the prioritized transfers and the round-robin transfers are queued by using a selection buffer, where the selection buffer has a depth equal to or greater than the sum of a depth of the first transfer buffer and a depth of the second transfer buffer.

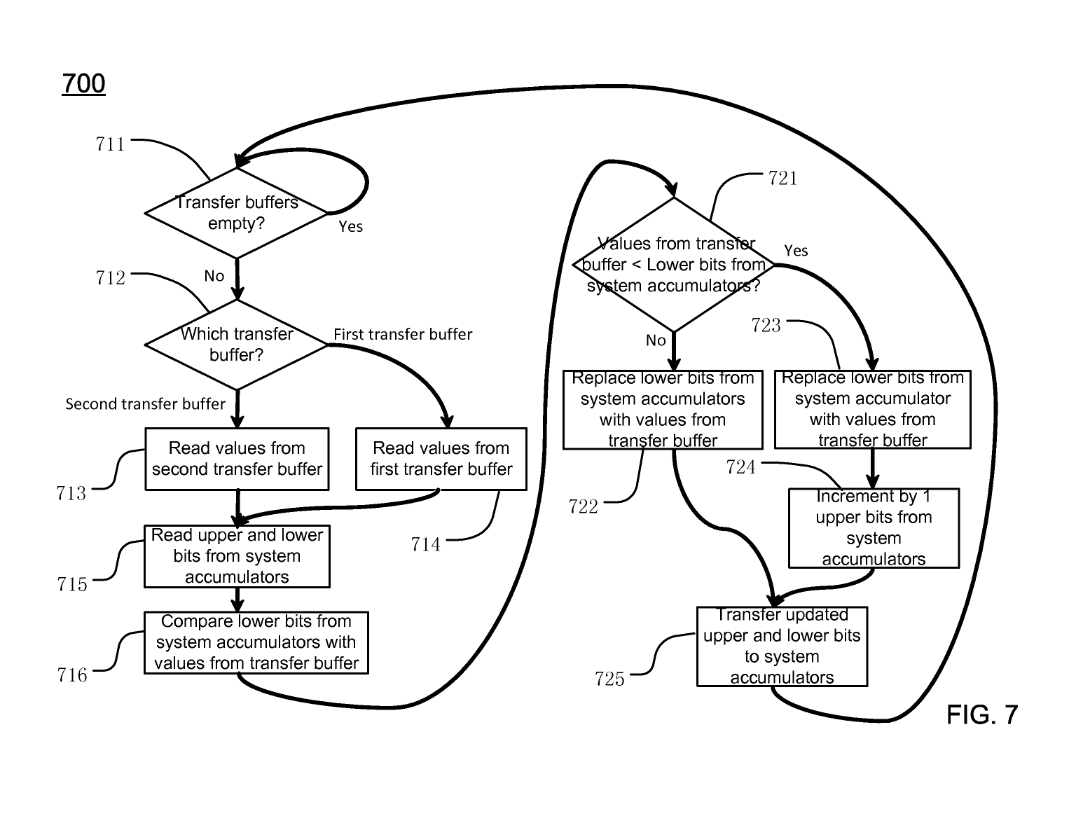

FIG. 2 illustrates a first transfer buffer 230, a second transfer buffer 240, and a selection buffer 250. FIG. 5 illustrates a flow chart for round-robin transfers. FIG. 6 illustrates a flow chart for prioritized transfers. FIG. 7 illustrates a flow chart for transferring values from the cached flow counters to the system accumulators in the order maintained by the selection buffer.

In an alternative implementation, the method may queue both the prioritized transfers and the round-robin transfers by using a single buffer, and maintain the order in which the prioritized transfers and the round-robin transfers are queued by maintaining an order in which the prioritized transfers and the round-robin transfers are queued into the single buffer.

FIG. 5 is a flow chart for round-robin maintenance transfers 500. With a round-robin maintenance transfer schedule, maintenance is scheduled on a time basis, such as the round-robin period (P_{RR}). The round-robin period (P_{RR}) may be maintained by a timer. The round-robin maintenance approach transfers the values from the cached flow counters to the second transfer buffer 240 (FIG. 2). Description for FIG. 7 explains how contents of the second transfer buffer 240 are transferred to the system accumulators. Transfer schedule 500 uses an index N to identify flows among the multiplicity of flows. The index N may be implemented with a counter in the processor.

Transfer schedule 500 first tests whether it is the time to perform maintenance according to the round-robin period (510). If it is the time, the system checks whether the second transfer buffer 240 is full. If the buffer is full, the system waits until the buffer is less than full (520). As explained in FIG. 7, the buffer may become less than full as a result of the action corresponding to block 713. If the second transfer buffer 240 is not full, the system reads values from the cached flow counters for a particular flow #N (530), and resets the last serviced counter (LSC) for the particular flow #N (540). Next, the system writes values from the cached flow counters for flow #N, including a flow number, to the second transfer buffer (550). The system also makes an entry in the selection buffer 250 (FIG. 2) to indicate that the flow #N is queued in the second transfer buffer (560). The system updates the cached flow counters for flow #N with information such as the updated value of the last serviced counter when it is reset (570). Finally, the system increments the index N to prepare for the next flow (580). When values from cached flow counters for all flows among the multiplicity of flows have been transferred to the system accumulators in one round of maintenance, the system resets the index N, getting ready for the next round of round-robin maintenance.

FIG. 6 is a flow chart for an evaluation-based maintenance this approach. The evaluation-based maintenance this approach first tests whether a frame in a particular flow #M among the multiplicity of flows has been received (611). If the frame has been received, the transfer approach reads values from cached flow counters for a particular flow #M into counters in the processor (613). The cached flow counters may include one or more regular operation counters including the last serviced counter, and one or more error condition counters. Values read from cached flow counters for flow #M may be referred to as statistics for flow #M. The first transfer buffer 230 maintains a fill level to indicate the fullness of the buffer. The transfer approach evaluates whether to transfer values from the cached flow counters to the first transfer buffer by using at least a value in the last serviced counter (LSC) for the particular flow #M. The evaluating includes comparing the fill level of the first transfer buffer to predetermined level (n) (615), and comparing the value in the last serviced counter (LSC) for flow #M to at least one transfer evaluation threshold (n) (617).

This approach adapts the at least one transfer evaluation threshold (n) used based on a fill level of a transfer function between the cached flow counters and the system accumulators, using a lower transfer evaluation threshold (n) when the transfer buffer is less full. For instance, the n may range from 0 to 3 for level (n) and threshold (n) as shown in FIG. 6. Level (n) and Threshold (n) in blocks 621, 623, 625, and 627 may have the following example values:

| Block in FIG. 6 | n | Level (n) | Threshold (n) |
|---|---|---|---|
| 621 | 0 | 0 | 1 |
| 623 | 1 | 4 | 16 |
| 625 | 2 | 16 | 64 |
| 627 | 3 | 31 | 256 |

This approach proceeds as follows: For n=0 to 3, if the fill level of the first transfer buffer is less than or equal to level (n), compare the value in the last serviced counter (LSC) to threshold (n) (621-627). If the comparison returns true for any n, reset the last serviced counter (631) for the particular flow #M, update values from cached flow counters for flow #M that are stored in the counters in the processor (633), write the updated values for flow #M including the flow number to the first transfer buffer (635), and write selection information to the selection buffer to indicate that an entry is made in the first transfer buffer (637). If the comparison does not return true for any n, this approach updates values from cached flow counters for the particular flow #M (629). For blocks 633 and 629, at least the last serviced counter and the received frame counter for a particular flow are updated.

Finally, this approach updates the set of cached flow counters for flow #M with the updated values for flow #M in the counters in the processor (639). The set of cached flow counters may include one or more regular operation counters including the last serviced counter, and one or more error condition counters.

FIG. 7 is a flow chart for this approach of updating system accumulators in system memory, for example, with values from the first transfer buffer and the second transfer buffer. Hybrid transfer approach 700 first tests whether the transfer buffers are empty (711). If the transfer buffers are not empty, this approach determines whether to transfer values from the first transfer buffer or the second transfer buffer by using the selection buffer (712). Since the selection buffer keeps the order in which values from cached flow counters are written to either the first or the second transfer buffer, the values are read out of the transfer buffers in the same order as they are written (713 or 714). Values read out of either the first or the second transfer buffer are for a particular flow and include the flow number of the particular flow.

The system accumulators include lower sub-accumulators with the same lengths as the cached flow counters or a transfer buffer, and upper sub-accumulators. The lower sub-accumulators and the upper sub-accumulators store lower bits and upper bits of the system accumulators, respectively. This approach reads upper bits and lower bits from system accumulators corresponding to the particular flow into counters in the computing system 130 (715).

The lower bits of the system accumulators correspond to values from the transfer buffer. This approach compares the lower bits from the system accumulators with values from the transfer buffer (716). In the counters in the processor, this approach replaces the lower bits from the system accumulators with the values from the transfer buffer, which are from the cached flow counters (722, 723). If the values from the cached flow counters are less than lower bits from the system accumulators (721), this approach increments, for example by 1, the upper bits from the system accumulators, in the counters in the processor (724). Finally, this approach transfers updated lower bits and upper bits from the counters in the processor to the system accumulators (725), thus, incrementing the upper sub-accumulators when the values from the cached flow counters are less than values from the corresponding lower sub-accumulators, and storing the values from the cached flow counters in the lower sub-accumulators.

In addition to the upper limit (Lᵤₚₚₑᵣ) for the size of the set of cached flow counters, a lower limit (L_{lower}) for the size of the set of cached flow counters may also be derived. Parameters and example values used for Lᵤₚₚₑᵣ are used for L_{lower}:
N_{flow}=number of flows in the multiplicity of flows=2¹⁴=16,384
T_{xfer}=time to transfer values in cached flow counters for one flow to system memory=10 μ=10×10⁻⁻⁶ seconds
Rₗᵢₙₑ=a communication line rate for the multiplicity of flows=1 GbE=10⁹ bitsper second
S_{frame}=minimum frame size including a preamble and a gap=672 bits
T_{frame}=minimum frame spacing=S_{frame}/Rₗᵢₙₑ=672 ns
P_{RR}=round-robin period=N_{flow}×T_{xfer}=163,840 μs
N_{RR}=number of frames received in P_{RR}=P_{RR}/T_{frame}=0.244 million frames

In this example, the worst case is when only one flow is active, running at 1.488 million frames per second. In this case, up to 0.244 million frames (N_{RR}), or about 2¹⁸ frames, may occur during the round robin period (P_{RR}), and at least 18 bits are required for the size of the set of cached flow counters, if the round-robin maintenance transfer approach is used in scheduling transfers to the system memory. Thus it is desirable to decrease the size of cached flow counters.

However, as the size of cached flow counters decreases, the number of prioritized transfers of values from the cached flow counters for frames received within a round robin period may increase. Consequently, the total time for the prioritized transfers may increase within the round-robin period. Example calculations are provided in the table below. The number of prioritized transfers is calculated as the number of frames transferred in a round-robin period (N_{RR}) divided by the frame count of cached flow counters (C_{frame}). The time to make the prioritized transfers is calculated as the time to transfer values for one flow to the system memory (T_{xfer}) times the number of prioritized transfers. For instance, when the frame count of cached flow counters is 14, the time to make the prioritized transfers reaches 174,286 μs, exceeding the round-robin period 163,840 μs.

| Frame Count of | Number of Prioritized | Time to Make the |
|---|---|---|
| Cached Flow Counters | Transfers | Prioritized Transfers (μs) |
| 256 | 953 | 9,531 |
| 128 | 1,906 | 19,063 |
| 64 | 3,813 | 38,125 |
| 32 | 7,625 | 76,250 |
| 16 | 15,250 | 152,500 |
| 14 | 17,429 | 174,286 |

To ensure that, with the worst case, the total time to make the prioritized transfers does not exceed the round robin period (P_{RR}), the method reduces a size for a set of cached flow counters from an upper limit (Lᵤₚₚₑᵣ) required by round-robin transfers to a smaller size approaching a lower limit (L_{lower}), where the lower limit (L_{lower}) is derived from:

P_{RR}=T_{xfer}×N_{RR}/C_{frame} (1)

Rearranging (1),

C_{frame}=T_{xfer}×N_{RR}/P_{RR} (2)

Substituting N_{RR}=P_{RR}/T_{frame}, and T_{frame}=S_{frame}/Rₗᵢₙₑinto (2),

C_{frame}=T_{xfer}×Rₗᵢₙₑ/S_{frame} (3)

Converting frame counts to corresponding size in bits,

L_{lower}=1+log₂ (C_{frame}) (4)

Substituting (3) into (4),

L_{lower}=1+log₂ (T_{xfer}×Rₗᵢₙₑ/S_{frame})

where L_{lower} is the lower limit, log₂ is logarithm base 2, T_{xfer} is the time to transfer values in cached flow counters for one flow among the multiplicity of flows to the system memory, Rₗᵢₙₑ is a communication line rate for the multiplicity of flows, and S_{frame} is a frame size for the multiplicity of flows.

A ceiling function may be applied to the result of the logarithm such that any fraction in the result is rounded up to the nearest integer. The addition of one is to guarantee no loss of information when transferring the cached flow counters to the system memory. The frame size may be a minimum frame size in any of the flows in the multiplicity of flows, an average minimum frame size in the flows, or an average expected frame size in the flows. Cached flow counters with sizes lower than L_{lower} may risk loss of information, at least when prioritized transfers are used.

Using the example described, T_{xfer}=10×10⁻⁶ seconds, Rₗᵢₙₑ=1 GbE=1×10⁹ bits per second, and S_{frame}=672 bits. Consequently, the lower limit (L_{lower}) for the bits size of cached flow counters is:

L_{lower}=1+ceiling (log₂ (10×10^{-6×10}⁹/672))=5 (bits)

where a ceiling function is applied to the result of the logarithm. The lower limit (L_{lower}) increases with increasing communication line rates (Rₗᵢₙₑ). For instance, if the communication line rate (Rₗᵢₙₑ) is increased to 100 GbE (100×10⁹ bits per second), the bits size of cached flow counters is increased to:

L_{lower}=1+ceiling (log₂(10×10^{-6×100×10}⁹/672))=12 (bits)

In summary, using the technology disclosed, the size of cached flow counters may be reduced from the upper limit (Lᵤₚₚₑᵣ) required by round-robin transfers to a smaller size approaching the lower limit (L_{lower}). If the time to transfer values in cached flow counters for one flow to system memory (T_{xfer}) is constant for a system and the minimum frame size (S_{frame}) is constant for a set of multiplicity of flows, then the lower limit (L_{lower}) for the size of cached flow counters can be a function of the communication line rate (R_{frame}). For instance, at a communication line rate of 100 GbE, the technology disclosed can reduce the size of cached flow counters from an upper limit (Lᵤₚₚₑᵣ) of 26 bits required by round-robin transfers to a smaller size approaching a lower limit (L_{lower}) of 12 bits. When fewer bits are required for each cached flow counter, more cached flow counters can fit in the same cache memory, as compared to a round-robin maintenance transfer schedule.

In addition to reducing the size of cached flow counters, the technology disclosed may lower the transfer rate for statistics from the cached flow counters to the system accumulators. Using the 1 GbE example, during the transfer time of 10 μs (T_{xfer}), about 15 frames may be received (=T_{xfer}/T_{frame}=10 μs/672 ns). Thus with round-robin transfers, each transfer may include statistics for 15 frames received. In comparison, with prioritized transfers, if the last serviced counter reaches 64, 128, or 256, each transfer may include statistics for 64, 128, or 256 frames received, respectively. Since each transfer may include statistics for more frames than with round-robin transfers, fewer transfers take place with prioritized transfers, under the same conditions such as the same number of flows, the same time to make each transfer, the same communication line rate, and the same frame size.

The evaluation-based maintenance transfer approach is active when a frame is received, and thus serves faster flows than the round-robin maintenance transfer schedule. The faster the flows, the more often the evaluation-based maintenance transfer approach is used. The evaluation-based maintenance transfer approach is more efficient because it avoids unnecessary transfers. The round-robin maintenance transfer schedule uses more transfer capacity than the evaluation-based maintenance transfer approach. Combining a round-robin maintenance transfer schedule with evaluation-based transfers can help with transferring statistics, but it is not needed to reduce the size of the cached flow counters.

The technology disclosed scales with the number of flows. For 64,000 flows, simulations have shown that with one million flows at 10 GbE line rate, the technology disclosed performs with no information loss in the cache memory before it is transferred to the system memory. The technology disclosed can be used with different communication line rates, such as 1 GbE, 10 GbE, 20 GbE, 40 GbE, and 80 GbE.

The technology disclosed can be applied to Ethernet based and non-Ethernet based systems, and to systems other than communications systems. The technology disclosed can be applied to software applications where high speed counters can be accumulated by system memory at that operates at lower speeds.

As mentioned above, the technology disclosed may be implemented in a computing system for reducing cache memory requirements for recording statistics from testing with a multiplicity of flows. The computing system includes one or more processors configured to perform operations implementing methods as described and any of the features and optional implementations of the methods described.

### Particular Implementations

One implementation of the technology disclosed is a method that reduces cache memory requirements for processing a multiplicity of flows. The method includes receiving data corresponding to a frame in a particular flow among the multiplicity of flows. In response to the frame received, the method updates a set of cached flow counters in cache memory for the particular flow and evaluates whether to transfer values from the cached flow counters to system accumulators in system memory. The method updates one or more regular operation counters among the set of cached flow counters, including a last serviced counter. The method updates one or more conditional counters among the set of cached flow counters. The method evaluates whether to transfer the values from the cached flow counters using at least a value in the last serviced counter for the particular flow. Responsive to the evaluating, the method transfers the values from the cached flow counters to the system accumulators. In addition, the method may update, responsive to any error conditions detected, one or more condition counters among the set of cached flow counters. Additional implementations of the technology disclosed include corresponding systems, apparatus, and computer program products.

These and additional implementations can include one or more of the following features. In some implementations, the method interleaves the prioritized transfers according to description above with round-robin transfers of values from the cached flow counters to the system accumulators. The method further includes queueing the prioritized transfers and the round-robin transfers of the values from the cached flow counters, maintaining an order in which the prioritized transfers and the round-robin transfers are queued; and transferring the values from the cached flow counters to the system accumulators in the order maintained.

A further implementation may queue the prioritized transfers by using a first transfer buffer, queue the round-robin transfers by using a second transfer buffer, and maintain the order in which the prioritized transfers and the round-robin transfers are queued by using a selection buffer, where the selection buffer has a depth equal to or greater than the sum of a depth of the first transfer buffer and a depth of the second transfer buffer.

A further implementation may queue both the prioritized transfers and the round-robin transfers by using a single buffer, and maintain the order in which the prioritized transfers and the round-robin transfers are queued by maintaining an order in which the prioritized transfers and the round-robin transfers are queued into the single buffer.

In one implementation, the method evaluates by comparing the value in the last serviced counter to at least one transfer evaluation threshold, and by adapting the at least one transfer evaluation threshold used based on a fill level of a transfer buffer between the cached flow counters and the system accumulators, using a lower transfer evaluation threshold when the transfer buffer is less full.

In one implementation, the method resets the last serviced counter when the cached flow counters for the particular flow are transferred to the system accumulators.

In one implementation, the system accumulators include lower sub-accumulators with same lengths as the cached flow counters, and upper sub-accumulators, and the method increments the upper sub-accumulators when the values from the cached flow counters are less than values from the corresponding lower sub-accumulators, and stores the values from the cached flow counters in the lower sub-accumulators.

Another implementation of the method includes reducing a size for the set of cached flow counters from an upper limit required by round-robin transfers to a smaller size approaching a lower limit, wherein the lower limit is derived from:

lower limit=1+log₂ (T_{xfer}×Rₗᵢₙₑ/S_{frame})

wherein log₂ is logarithm base 2, T_{xfer} is the time to transfer values in cached flow counters for one flow among the multiplicity of flows to the system memory, Rₗᵢₙₑ is a communication line rate for the multiplicity of flows, and S_{frame} is a frame size for the multiplicity of flows.

The frame size may be a minimum frame size in any of the flows among the multiplicity of flows, an average minimum frame size among the multiplicity of flows, or an average expected frame size among the multiplicity of flows.

As mentioned above, the technology disclosed may be implemented in a computing system that reduces cache memory requirements for recording statistics from testing with a multiplicity of flows. The computing system includes one or more processors configured to perform operations implementing methods described and any of the features and optional implementations of the methods described.

The technology disclosed is described by reference to the figures and examples detailed above, it is understood that these examples are intended in an illustrative rather than in a limiting sense. Computer-assisted processing is implicated in the described implementations. Accordingly, the technology disclosed may be embodied in methods for reducing cache memory requirements for recording statistics from testing with a multiplicity of flows, systems including logic and resources to carry out reducing cache memory requirements for recording statistics from testing with a multiplicity of flows, systems that take advantage of computer-assisted reducing cache memory requirements for recording statistics from testing with a multiplicity of flows, media impressed with logic to carry out reducing cache memory requirements for recording statistics from testing with a multiplicity of flows, data streams impressed with logic to carry out reducing cache memory requirements for recording statistics from testing with a multiplicity of flows, or computer-accessible services that carry out computer-assisted reducing cache memory requirements for recording statistics from testing with a multiplicity of flows. It is contemplated that modifications and combinations will readily occur to those skilled in the art, which modifications and combinations will be within the spirit of the technology and the scope of the following claims.

We claim as follows:

1. A method that reduces cache memory requirements for recording statistics from processing a multiplicity of flows, including:
receiving data corresponding to a frame in a particular flow among the multiplicity of flows;
responsive to the frame, updating a set of cached flow counters in cache memory for the particular flow and evaluating whether to transfer values from the cached flow counters to system accumulators in system memory, including:
updating one or more regular operation counters among the set of cached flow counters, including a last serviced counter;
updating one or more conditional counters among the set of cached flow counters; and
evaluating whether to transfer the values from the cached flow counters using at least a value in the last serviced counter for the particular flow; and
responsive to the evaluating, transferring the values from the cached flow counters to the system accumulators.

2. The method of claim 1, wherein the updating the set of cached flow counters includes updating, responsive to any error conditions detected, one or more error condition counters among the set of cached flow counters.

3. The method of interleaving prioritized transfers according to claim 1 with round-robin transfers of values from the cached flow counters to the system accumulators, further including:
queueing the prioritized transfers and the round-robin transfers of the values from the cached flow counters;
maintaining an order in which the prioritized transfers and the round-robin transfers are queued; and
transferring the values from the cached flow counters to the system accumulators in the order maintained.

4. The method of claim 3, wherein:
the queueing includes queueing the prioritized transfers using a first transfer buffer, and queueing the round-robin transfers using a second transfer buffer; and
the maintaining includes maintaining the order using a selection buffer,
wherein the selection buffer has a depth equal to or greater than the sum of a depth of the first transfer buffer and a depth of the second transfer buffer.

5. The method of claim 3, wherein:
the queueing includes queueing both the prioritized transfers and the round-robin transfers using a buffer; and
the maintaining includes maintaining an order in which the prioritized transfers and the round-robin transfers are queued into the buffer.

6. The method of claim 1, wherein the evaluating includes:
comparing the value in the last serviced counter to at least one transfer evaluation threshold; and
adapting the at least one transfer evaluation threshold used based on a fill level of a transfer buffer between the cached flow counters and the system accumulators, using a lower transfer evaluation threshold when the transfer buffer is less full.

7. The method of claim 1, wherein the transferring includes resetting the last serviced counter when the cached flow counters for the particular flow are transferred to the system accumulators.

8. The method of claim 1, wherein the system accumulators include lower sub-accumulators with same lengths as the cached flow counters, and upper sub-accumulators, further including:
incrementing the upper sub-accumulators when the values from the cached flow counters are less than values from the corresponding lower sub-accumulators; and
storing the values from the cached flow counters in the lower sub-accumulators.

9. The method of claim 1, further including reducing a size for the set of cached flow counters from an upper limit required by round-robin transfers to a smaller size approaching a lower limit, wherein the lower limit is derived from:
lower limit=1+log₂ (T_{xfer}×Rₗᵢₙₑ/S_{frame})
wherein log₂ is logarithm base 2, T_{xfer} is the time to transfer values in cached flow counters for one flow among the multiplicity of flows to the system memory, Rₗᵢₙₑ is a communication line rate for the multiplicity of flows, and S_{frame} is a frame size for the multiplicity of flows.

10. The method of claim 9, wherein the logarithm base 2 is rounded up to a nearest integer.

11. The method of claim 9, wherein the frame size is a minimum frame size in any of the flows among the multiplicity of flows.

12. The method of claim 9, wherein the frame size is an average minimum frame size among the multiplicity of flows.

13. The method of claim 9, wherein the frame size is an average expected frame size among the multiplicity of flows.

14. A computing system that reduces cache memory requirements for recording statistics from processing a multiplicity of flows, the computing system including one or more processors configured to perform operations including:
receiving data corresponding to a frame in a particular flow among the multiplicity of flows;
responsive to the frame, updating a set of cached flow counters in cache memory for the particular flow, and evaluating whether to transfer values from the cached flow counters to system accumulators in system memory, including:
updating one or more regular operation counters among the set of cached flow counters, including a last serviced counter;
updating one or more conditional counters among the set of cached flow counters; and
evaluating whether to transfer the values from the cached flow counters using at least a value in the last serviced counter for the particular flow; and
responsive to the evaluating, transferring the values from the cached flow counters to the system accumulators.

15. The computing system of claim 14, wherein the updating a set of cached flow counters includes updating, responsive to any error conditions detected, one or more error condition counters among the set of cached flow counters.

16. The computing system of claim 14, wherein the processors configured to further perform operations including interleaving prioritized transfers according to claim 12 with round-robin transfers of values from the cached flow counters to the system accumulators, including:
queueing the prioritized transfers and the round-robin transfers of the values from the cached flow counters;
maintaining an order in which the prioritized transfers and the round-robin transfers are queued; and
transferring the values from the cached flow counters to the system accumulators in the order maintained.

17. The computing system of claim 16, wherein:
the queueing includes queueing the prioritized transfers using a first transfer buffer, and queueing the round-robin transfers using a second transfer buffer; and
the maintaining includes maintaining the order using a selection buffer,
wherein the selection buffer has a depth equal to or greater than the sum of a depth of the first transfer buffer and a depth of the second transfer buffer.

18. The computing system of claim 16, wherein:
the queueing includes queueing both the prioritized transfers and the round-robin transfers using a buffer; and
the maintaining includes maintaining an order in which the prioritized transfers and the round-robin transfers are queued into the buffer.

19. The computing system of claim 14, wherein the evaluating includes:
comparing the value in the last serviced counter to at least one transfer evaluation threshold; and
adapting the at least one transfer evaluation threshold used based on a fill level of a transfer buffer between the cached flow counters and the system accumulators, using a lower transfer evaluation threshold when the transfer buffer is less full.

20. The computing system of claim 14, wherein the transferring includes resetting the last serviced counter when the cached flow counters for the particular flow are transferred to the system accumulators.

21. The computing system of claim 14, wherein the system accumulators include lower sub-accumulators with same lengths as the cached flow counters, and upper sub-accumulators, wherein the processors configured to further perform operations including:
incrementing the upper sub-accumulators when the values from the cached flow counters are less than values from the corresponding lower sub-accumulators; and
storing the values from the cached flow counters in the lower sub-accumulators.

22. The computing system of claim 14, wherein the processors configured to further perform operations including reducing a size for the set of cached flow counters from an upper limit required by round-robin transfers to a smaller size approaching a lower limit, wherein the lower limit is derived from:
lower limit=1+log₂ (T_{xfer}×Rₗᵢₙₑ/S_{frame})
wherein log₂ is logarithm base 2, T_{xfer} is the time to transfer values in cached flow counters for one flow among the multiplicity of flows to the system memory, Rₗᵢₙₑ is a communication line rate for the multiplicity of flows, and S_{frame} is a frame size for the multiplicity of flows.

23. The computing system of 22, wherein the logarithm base 2 is rounded up to a nearest integer.

24. The computing system of claim 22, wherein the frame size is a minimum frame size in any of the flows among the multiplicity of flows.

25. The computing system of claim 22, wherein the frame size is an average minimum frame size among the multiplicity of flows.

26. The computing system of claim 22, wherein the frame size is an average expected frame size among the multiplicity of flows.
